(19) United States
(12) Patent Application Publication
(10) Pub. No.: US 2009/0048388 A1
(43) Pub. Date: Feb. 19, 2009

(54) Wear resistant toughened and reinforced polyacetal compositions

(76) Inventor: Andri E. Elia, Chadds Ford, PA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/893,581

(22) Filed: Aug. 16, 2007

(51) Int. Cl. C08L 59/00

(52) U.S. Cl. 524/502

(57) ABSTRACT

Polyacetal resin compositions having good wear resistance and a combination of good toughness and stiffness. The compositions comprise polyacetal, toughener, carbon fibers, and, optionally, glass fibers.

### FIELD OF THE INVENTION

The present invention relates to wear resistant polyacetal compositions having a combination of good toughness and stiffness.

### BACKGROUND OF THE INVENTION

Many applications require the use of parts that are in motion with respect to other parts with which they are in physical contact. Because many polymeric materials are light weight and have good physical properties and can be used to form a large variety of shapes, they are often used in such applications. However, the materials must often have good wear and fatigue resistance, particularly over prolonged use. Polyacetals (also known as polyoxymethylene or POM) are known to have excellent tribology and good physical properties and good wear resistance.

In many of these applications, it is also often important that the polymeric materials used have good mechanical properties such as toughness and stiffness, especially when exposed to heat. Unreinforced polyacetal compositions often have good elongations at yield and wear resistance, but can have insufficient stiffness, particularly at elevated temperatures, for some applications. Additives such as mineral fillers and fibrous reinforcing agents are often used to improve the physical properties of polymeric compositions, but when typical reinforcing reagents such as glass fibers are used in polyacetal compositions, the resulting improved mechanical properties can come at a price of often significant reductions in wear resistance.

It would be desirable to obtain a polyacetal composition having good elongation properties and stiffness while still having good wear resistance.

U.S. patent application Publication discloses polyoxymethylene molding compositions comprising compatibilizer, impact modifier, and polyoxymethylene. U.S. Pat. No. 5,817,723 teaches a toughened thermoplastic polymer composition comprising a polar toughening agent compatibilized with a polyphenol and at least one thermoplastic polymer.

### SUMMARY OF THE INVENTION

Disclosed herein is a polyacetal composition, comprising a blend of;
(i) about 65 to about 94 weight percent of at least one polyacetal;
(ii) about 1 to about 10 weight percent of at least one toughener comprising a copolymer comprising repeat units derived from ethylene and at least one compound of the formula H₂C═CR²CO₂R′, wherein R¹ is an alkyl group containing 1 to 6 carbon atom and R² is a methyl group or hydrogen; and
(iii) about 5 to about 25 weight percent of carbon fibers, and optionally, glass fibers,
   wherein the weight percentage of carbon fibers divided by the weight percentage of carbon fibers plus the weight percentage of glass fibers is between 0 and about 0.5, and wherein all weight percentages are based on the total weight of the composition.

Also disclosed herein is an article formed form the above described polyacetal composition.

### DETAILED DESCRIPTION OF THE INVENTION

The compositions of the present invention comprise a melt-mixed blend about 65 to about 94 weight percent of at least one thermoplastic polyacetal; about 1 to about 10 weight percent of a toughener; about 5 to about 25 weight percent of carbon fibers, and optionally, glass fibers.

The polyacetal can be one or more homopolymers, copolymers, or a mixture thereof. Homopolymers are prepared by polymerizing formaldehyde and/or formaldehyde equivalents, such as cyclic oligomers of formaldehyde. Copolymers are derived from one or more comonomers generally used in preparing polyacetals in addition to formaldehyde and/formaldehyde equivalents. Commonly used comonomers include acetals and cyclic ethers that lead to the incorporation into the polymer chain of ether units with 2-12 sequential carbon atoms. If a copolymer is selected, the quantity of comonomer will not be more than 20 weight percent, preferably not more than 15 weight percent, and most preferably about two weight percent. Preferable comonomers are 1,3-dioxolane, ethylene oxide, and butylene oxide, where 1,3-dioxolane is more preferred, and preferable polyacetal copolymers are copolymers where the quantity of comonomer is about 2 weight percent. It is also preferred that the homo- and copolymers are: 1) homopolymers whose terminal hydroxy groups are end-capped by a chemical reaction to form ester or ether groups; or, 2) copolymers that are not completely end-capped, but that have some free hydroxy ends from the comonomer unit or are terminated with ether groups. Preferred end groups for homopolymers are acetate and methoxy and preferred end groups for copolymers are hydroxy and methoxy. The polyacetal will preferably be linear (unbranched) or have minimal chain-branching.

The polyacetal used in the compositions of the present invention can be branched or linear and will preferably have a number average molecular weight of at least 10,000, and preferably about 20,000 to about 90,000. The molecular weight can be conveniently measured by gel permeation chromatography in m-cresol at 160° C. using a DuPont PSM bimodal column kit with nominal pore size of 60 and 1000 Angstroms (Å). The molecular weight can also be measured by determining the melt flow using ASTM D1238 or ISO 1133. The melt flow will preferably be in the range of 0.1 to 100 g/min, more preferably from 0.5 to 60 g/min, or yet more preferably from 0.8 to 40 g/min. for injection molding purposes.

The polyacetal is present in the composition in about 65 to about 94 weight percent, or preferably in about 75 to about 94 weight percent, or more preferably in about 83.5 to about 92 weight percent, based on the total weight of the composition.

The toughener used in the composition is at least one copolymer comprising repeat units derived from ethylene; at least one compound of the formula H₂C═CR²CO₂R′, wherein R¹ is an alkyl group containing 1 to 6 carbon atom and R² is a methyl group or hydrogen; and optionally, additional monomers. Preferred additional monomers include carbon monoxide and glycidyl methacrylate.

Preferred tougheners include ethylene/n-butyl acrylate/carbon monoxide copolymers and ethylene/n-butyl acrylate/glycidyl methacrylate copolymers.

The toughener is present in the composition in about 1 to about 10 weight percent, or preferably in about 3 to about 7.5 weight percent, based on the total weight of the composition.

Carbon fibers typically used as fillers/reinforcing agents for thermoplastics may be used in the composition of the present invention, and may be sized or unsized, but it is preferred that the carbon fiber be sized with a sizing designed for polyacetals. The carbon fibers may be made in a number of ways, for instance they may be “pitch based” or made from polyacrylonitrile. Some or all of the carbon fibers may be present in the composition as long or continuous fibers.

The composition may optionally contain glass fibers. The glass fibers may be sized or unsized, but it is preferred that they be sized with a sizing designed for polyacetals. Some or all of the glass fibers may be present in the composition as long or continuous fibers.

As used herein, “C” refers to the weight percentage of carbon fibers present in the composition and “G” refers to the weight percentage of glass fibers present in the composition.

The total amount of carbon fibers and glass fibers (C+G) is present in the composition in about 5 to about 25 weight percent, or preferably in about 5 to about 15 weight percent, or more preferably in about 5 to about 9 weight percent, based on the total weight of the composition. Additionally, G/(C+G) is 0 to about 0.5, or preferably 0 to about 0.5, or more preferably 0 to 0.1.

The composition of the present invention may optionally comprise other additives such as lubricants, processing aids, stabilizers (such as thermal stabilizers, oxidative stabilizers, ultraviolet light stabilizers), colorants, nucleating agents, compatibilizers, tougheners, fluoropolymer such as poly(tetrafluoroethylene), plasticizers, reinforcing agents and fillers (such as glass fibers, wollastonite, mineral fillers, and nanofillers).

The polyacetal compositions of the present invention are made by melt-blending the components using any known or conventional methods. The component materials may be mixed thoroughly using a melt-mixer such as a single or twin-screw extruder, blender, kneader, Banbury mixer, etc. to give a resin composition. Or, part of the materials may be mixed in a melt-mixer, and the rest of the materials may then be added and further thoroughly melt-mixed. The carbon and/or glass fibers may also be added to the compositions using a method such as pultrusion that yields materials having relatively long carbon and/or glass fiber lengths.

The compositions of the present invention can be formed into articles using any suitable technique known in the art, such as melt-processing techniques. Commonly used melt-molding methods known in the art such as injection molding, extrusion molding, blow molding, rotational molding, coining, and injection blow molding are preferred and injection molding is more preferred. The compositions of the present invention can be formed into sheets and both cast and blown films by extrusion. These films and sheets may be further thermoformed into articles and structures that can be oriented from the melt or at a later stage in the processing of the composition. The compositions may be overmolded onto an article made from a different material. The articles may also be formed using techniques such as compression molding or ram extruding. The articles may be further formed into other shapes by machining.

Examples of suitable articles include gears; rods; sheets; strips; channels; tubes; conveyor system components such as wear strips, guard rails, rollers, and conveyor belt parts. The articles may be tubes for use in automobiles.

### EXAMPLES

The compositions of the examples and comparative examples were prepared by melt-blending the ingredients shown in Tables 1-3 in a 30 mm twin-screw extruder, with the exception that in the cases of Comparative Examples 1 and 10-12, the polyacetals were used as commercially supplied. As used in Tables 1 and 2, “G” refers to the weight percent of glass fibers, “C” refers to the percent of carbon fibers, and “T” refers to the weight percent of toughener.

The compositions were molded into test specimens according to ASTM D638 and tensile modulus and percent elongation at yield were determined according ASTM D638 at a speed of 5 mm/min. The results are given in Tables 1-3. It is preferred that the elongation at break be at least about 10 percent.

### Wear Testing

The compositions were injection molded into test pieces. The test pieces were disks having three flat pads protruding from one surface of the disk. The pads protruded about 0.125 in from the surface of the disk and their combined surface area was about 0.2128 in².

Wear testing was done by holding a test piece molded from the composition to be tested against a countersurface, such that the pads were in contact with the countersurface, under the action of a controlled force (or pressure), P, while rotating the test piece against the countersurface at a relative velocity, V. The countersurface was 600 grit sandpaper having abrasive particles of about 25 micrometers in median size adhered to a backing paper. A linear variable displacement transducer in the testing apparatus measured the decrease in distance between the test piece and abrasive surface (L). The test was run until at least about a third of the height of the pads had worn away, or 400 hours, whichever came first. Tests were run with a pressure of 79 p.s.i. and a velocity of 63 feet per minute (fpm).

The wear factor was calculated by the following formula:

wear factor=L/(P×V×t)

where: L is in inches, P is in p.s.i., V is in fpm, and t is the duration of the test in minutes. The results are shown in Tables 1-3. It is preferred that the wear factor be no greater than about 400 in³/lbf·ft.
The following ingredients are referred to in the Tables:
Polyacetal A refers to Delrin® 560, a polyacetal copolymer supplied by E.I. du Pont de Nemours & Co.
Polyacetal B refers to Delrin® 500, a polyacetal homopolymer supplied by E.I. du Pont de Nemours & Co.
Polyacetal C refers to Delrin® 510, a polyacetal homopolymer containing 10 weight percent glass fibers supplied by E.I. du Pont de Nemours & Co.
Polyacetal D refers to Delrin® 525, a polyacetal homopolymer containing 25 weight percent glass fibers supplied by E.I. du Pont de Nemours & Co.
Glass fibers refers to OCF 408A14P supplied by Owens-Corning.
Carbon fibers refers to Fortafil® 201 supplied by Toho-Tenax
Toughener A refers to an ethylene/n-butyl acrylate/carbon monoxide (57/33/10 wt. %) copolymer.
Toughener B refers to Texin® 285, a thermoplastic polyurethane supplied by Bayer.

TABLE 1

| | Comp. | | | Comp. | Comp. | | | | | | Comp. | | Comp. |
|---|---|---|---|---|---|---|---|---|---|---|---|---|---|
| | Ex. 1 | Ex. 1 | Ex. 2 | Ex. 2 | Ex. 3 | Ex. 3 | Ex. 4 | Ex. 5 | Ex. 6 | Ex. 7 | Ex. 5 | Ex. 8 | Ex. 5 |
| Polyacetal A | 100 | 87.5 | 68.5 | 87.5 | 67.5 | 90 | 70 | 85 | 65 | 80 | 80 | 75 | 75 |
| Glass fibers | — | 0.5 | 1.5 | 4.5 | 22.5 | 2.5 | 12.5 | 2.5 | 12.5 | 1.5 | 13.5 | 1.5 | 13.5 |
| Carbon | — | 4.5 | 22.5 | 0.5 | 2.5 | 2.5 | 12.5 | 2.5 | 12.5 | 13.5 | 1.5 | 13.5 | 1.5 |
| fibers | | | | | | | | | | | | | |
| Toughener A | — | 7.5 | 7.5 | 7.5 | 7.5 | 5 | 5 | 10 | 10 | 5 | 5 | 10 | 10 |
| Total G + C | 0 | 5 | 25 | 5 | 25 | 5 | 25 | 5 | 25 | 15 | 15 | 15 | 15 |
| G/(C + G) | 0 | 0.1 | 0.1 | 0.9 | 0.9 | 0.5 | 0.5 | 0.5 | 0.5 | 0.1 | 0.9 | 0.1 | 0.9 |
| Elongation at | 44.2 | 28.2 | 4.0 | 25.7 | 6.9 | 24.2 | 4.5 | 31.2 | 5.0 | 7.4 | 14.6 | 11.1 | 15.1 |
| yield (%) | | | | | | | | | | | | | |
| Tensile | 2927 | 4737 | 12304 | 3625 | 9050 | 4256 | 11079 | 3892 | 9726 | 9904 | 5842 | 8386 | 5501 |
| modulus | | | | | | | | | | | | | |
| (MPa) | | | | | | | | | | | | | |
| Wear factor | 86 | 157 | 121 | 1471 | 506 | 181 | 217 | 362 | 157 | 217 | 868 | 133 | 1133 |
| (in³/lbf · ft) | | | | | | | | | | | | | |

Ingredient quantities are given in weight percentages based on the total weight of the composition.

TABLE 2

| | | | | Comp. | Comp. | Comp. | Comp. |
|---|---|---|---|---|---|---|---|
| | Ex. 9 | Ex. 10 | Ex. 11 | Ex. 6 | Ex. 7 | Ex. 8 | Ex. 9 |
| Polyacetal A | 77.5 | 77.5 | 77.5 | 85 | 85 | 85 | 78 |
| Glass fibers | 7.5 | 7.5 | 7.5 | 15 | — | 7.5 | 7.5 |
| Carbon fibers | 7.5 | 7.5 | 7.5 | — | 15 | 7.5 | 7.5 |
| Toughener A | 7.5 | 7.5 | 7.5 | — | — | — | — |
| Toughener B | — | — | — | — | — | — | 7.5 |
| Total G + C | 15 | 15 | 15 | 15 | 15 | 15 | 15 |
| G/(C + G) | 0.5 | 0.5 | 0.5 | 1 | 0 | 0.5 | 0.5 |
| Elongation at yield (%) | 11.9 | 11.1 | 11.3 | 2.5 | 1.3 | 1.3 | 1.9 |
| Tensile modulus (MPa) | 7875 | 7802 | 7869 | 5576 | 10646 | 8141 | 6884 |
| Wear factor (in³/lbf · ft) | 169 | 205 | 169 | 5618 | 133 | 229 | 193 |

Ingredient quantities are given in weight percentages based on the total weight of the composition.

TABLE 3

| | Comp. | Comp. | Comp. | | | | | |
|---|---|---|---|---|---|---|---|---|
| | Ex. 10 | Ex. 11 | Ex. 12 | Ex. 12 | Ex. 13 | Ex. 14 | Ex. 15 | Ex. 16 |
| Polyacetal B | 100 | — | — | 92 | 90 | 87 | 87 | 83 |
| Polyacetal C | — | 100 | — | — | — | — | — | — |
| Polyacetal D | — | — | 100 | — | — | — | — | — |
| Carbon fibers | | | | 5 | 5 | 8 | 8 | 10 |
| Toughener A | | | | 3 | 5 | 5 | 5 | 7 |
| Elongation at yield (%) | 45 | 3.4 | 2.7 | 9.9 | 17.4 | 15.5 | 8.3 | 1.6 |
| Tensile modulus (MPa) | 3200 | 5601 | 9795 | 5302 | 5371 | 8472 | 8068 | 8717 |
| Wear factor (in³/lbf · ft) | 116 | 1918 | 1112 | | | | | |

Ingredient quantities are given in weight percentages based on the total weight of the composition.

What is claimed is:

1. A polyacetal composition, comprising a blend of;
(iv) about 65 to about 94 weight percent of at least one polyacetal;
(v) about 1 to about 10 weight percent of at least one toughener comprising a copolymer comprising repeat units derived from ethylene and at least one compound of the formula H₂C═CR²CO₂R¹, wherein R¹ is an alkyl group containing 1 to 6 carbon atom and R² is a methyl group or hydrogen; and
(vi) about 5 to about 25 weight percent of carbon fibers, and optionally, glass fibers,
wherein the weight percentage of carbon fibers divided by the weight percentage of carbon fibers plus the weight percentage of glass fibers is between 0 and about 0.5, and wherein all weight percentages are based on the total weight of the composition.

2. The composition of claim 1, wherein the polyacetal is a homopolymer.

3. The composition of claim 1, wherein the polyacetal is a copolymer.

4. The composition of claim 1, wherein the toughener is ethylene/n-butyl acrylate/carbon monoxide copolymer.

5. The composition of claim 1, wherein the toughener is ethylene/n-butyl acrylate/glycidyl methacrylate copolymer.

6. The composition of claim 1, comprising about 75 to about 94 weight percent polyacetal (i); about 1 to about 10 weight percent toughener (ii); and about 5 to about 15 weight percent carbon fibers, and optionally, glass fibers (iii), wherein the weight percentages are based on the total weight of the composition.

7. The composition of claim 1, comprising about 83.5 to about 92 weight percent polyacetal (i); about 3 to about 7.5 weight percent toughener (ii); and about 5 to about 9 weight percent carbon fibers, and optionally, glass fibers (iii), wherein the weight percentages are based on the total weight of the composition.

8. The composition of claim 1, wherein the weight percentage of carbon fibers divided by the weight percentage of carbon fibers plus the weight percentage of glass fibers is between 0 and about 0.1.

9. An article formed form the composition of claim 1.

10. The article of claim 8 in the form of a gear.

11. The article of claim 8 in the form of rod, sheet, strip, channel, or tube.

12. The article of claim 8 in the form of a conveyer system wear strip, guard rail, roller, or conveyer belt part.
